(19) United States
(12) Patent Application Publication
(10) Pub. No.: US 2022/0099122 A1
(43) Pub. Date: Mar. 31, 2022

(54) Coupler

(71) Applicant: Marcos Antonio Gomez, Marietta, GA (US)

(72) Inventor: Marcos Antonio Gomez, Marietta, GA (US)

(21) Appl. No.: 17/468,433

(22) Filed: Sep. 7, 2021

Related U.S. Application Data
(60) Provisional application No. 63/075,079, filed on Sep. 4, 2020.

(51) Int. Cl. F16B 7/04

(52) U.S. Cl. CPC F16B 7/0406; F16L 37/096

(57) ABSTRACT

One or more embodiments of a coupling device including a first connector, a body and a locking insert. The first connector is configured to connect to a first device. The body defines a first opening on a first side of the body and a second opening on a second side of the body different from the first side of the body. The first opening is configured to receive a portion of a second device. The first opening and the second opening connect. The first connector is fixed to the body via a third side. The locking insert is configured to enter the second opening and secure the portion of the second device in the first opening.

### CROSS REFERENCE TO RELATED APPLICATIONS

This application claims priority to provisional application No. 63/075,079, which was filed on Sep. 4, 2020, which is incorporated in its entirety.

### FIELD OF THE DISCLOSURE

The present invention relates to coupling devices.

### BACKGROUND

Coupling devices such as hose couplers, carabiners, clamping couplers, etc. may be used to couple two devices. Some of these devices are useful for quick disconnection. Others provide very secure connections. Some couplers provide permanent connection while others provide for easy disconnection. However, currently available couplers do not provide for quick connection/disconnection with a very secure connection.

### SUMMARY

One or more embodiments are provided below for a coupling device. The device may include a first connector, a body, and a locking insert. The first connector may be configured to connect to a first device. The body may define a first opening on a first side of the body and a second opening on a second side of the body different from the first side of the body. The first opening may be configured to receive a portion of a second device. The first opening and the second opening may connect. The first connector may be fixed to the body via a third side. The locking insert may be configured to enter the first opening and secure a portion of the second device in the first opening.

The coupling device may provide significant advantages over the devices known in the art. The coupling device may provide a coupler which is easy to use, with very quick connection/disconnection and a very sturdy and strong coupling.

Other advantageous features as well as other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1A shows an example side view of the male coupler and the female coupler.

FIG. 1B shows an example side view of the male coupler and the female coupler when connected.

FIG. 1C shows an example front view of the male coupler and the female coupler.

FIG. 2A shows a side view of another example of the male coupler and the female coupler.

FIG. 2B shows another example side view of the male coupler and the female coupler when connected.

FIG. 3A shows another example side view of the male coupler and the female coupler.

FIG. 3B shows another example side view of the male coupler and the female coupler when connected.

FIG. 3C shows another example front view of the male coupler and the female coupler.

FIG. 4A shows another example side view of the male coupler and the female coupler.

FIG. 4B shows another example side view of the male coupler and the female coupler when connected.

FIGS. 5A-5C show example side views of the shaft and head of the latch.

FIG. 6 shows an example side view of the male and female couplers connecting a suppressor to a firearm.

FIG. 7 shows another example side view of the male and female couplers connecting a suppressor to a firearm.

FIG. 8 shows an example top view of a second male coupler and a second female coupler

FIG. 9 shows an example side view of the second male coupler and the second female coupler.

FIG. 10 shows an example side view of the second male coupler and the second female coupler coupled together.

FIG. 11 shows component parts of the female coupler.

FIG. 12 shows the second male coupler and the second female coupler used to connect a stabilizer to a bow.

### DETAILED DESCRIPTION

In the Summary above and in this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “coupled to” as used herein may mean a direct or indirect connection via one or more components.

Referring now to the drawings and the following written description of the present invention, it will be readily understood by those persons skilled in the art that the present invention is susceptible to broad utility and application. Many embodiments and adaptations of the present invention other than those herein described, as well as many variations, modifications, and equivalent arrangements will be apparent from or reasonably suggested by the present invention and the detailed description thereof, without departing from the substance or scope of the present invention. This disclosure is only illustrative and exemplary of the present invention and is made merely for purposes of providing a full and enabling disclosure of the invention.

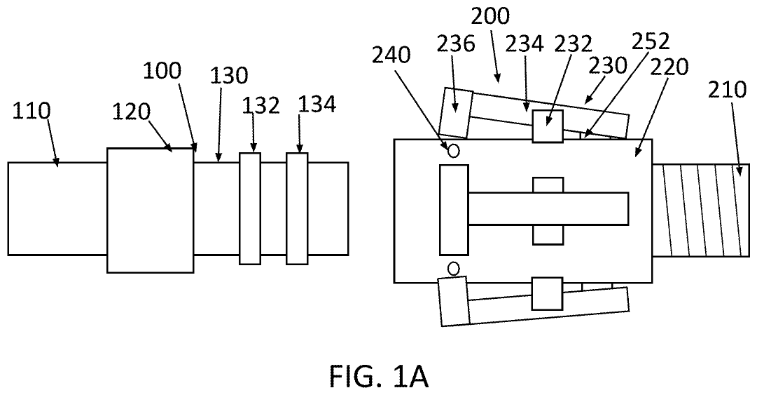

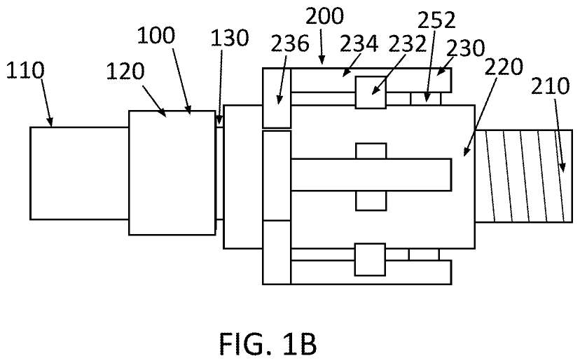

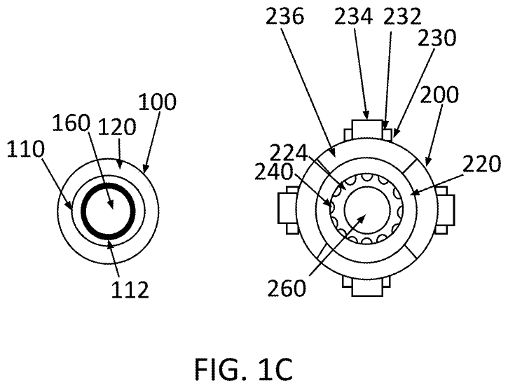

FIG. 1A shows an example side view of the male coupler 100 and the female coupler 200 according to a first embodiment of the inventive concepts. The male coupler 100 may be generally cylindrical in shape and include a first fixing portion 110, a central portion 120 and a second fixing portion 130. The male coupler 100 may include a metal such as steel. The first fixing portion 110 may include threading (not shown in this figure) or other similar devices in an interior of the first fixing portion 110 for fixing the male coupler 100 to an object such as a firearm (not shown in this figure). The central portion 120 may be wider than the first fixing portion 110 and the second fixing portion 130. The second fixing portion 130 may include a first fixing ridge 132 and a second fixing ridge 134. The first fixing ridge 132 and the second fixing ridge 134 may be wide portions of the second fixing portion with a gap therebetween.

The female coupler 200 may include a first fixing portion 210, a second fixing portion 220, latches 230, securing bearings 240, and a first holder 252. The female coupler 200 may include a metal such as steel. The first fixing portion 210 may be threaded to screw onto an object such as a silencer (not shown in this figure). Alternatively, the first fixing portion 210 may include other mechanisms for coupling the female coupler 200 to an object. The second fixing portion 220 may include an opening (not shown in this figure) configured to receive the second fixing portion 130 of the male coupler 100.

The latches 230 may be fixed to the second fixing portion 220. The latches 230 may include a base 232, a shaft 234, and a first head 236. The base 232 may be attached to the second fixing portion 220 and be attached to the shaft 234 such that the shaft 234 may rotate relative to the base 232. The first head 236 may be attached to the shaft 234. The rotation of the shaft 234 may cause the first head 236 to rotate to and from a position for securing the female coupler 200 to the male coupler 100. In the example embodiment shown in FIGS. 1A-1C, the position for securing the female coupler 200 to the male coupler 100 is a position where the first head 236 contacts the securing bearings 240. The first holder 252 is configured to apply a force to the shaft 234 to push the first head 236 into the position for securing the female coupler 200 to the male coupler 100. The first holder 252 may include a spring, a metal tang, or any other device or mechanism capable of applying a force on shaft 234. The first holder 252 may be positioned on the opposite side of base 232 as the first head 236.

FIG. 1B shows an example side view of the male coupler 100 and the female coupler 200 when connected according to the first embodiment of the inventive concepts. As shown, the second fixing portion 130 of the male coupler 100 may slide into the second fixing portion 220 of the female coupler 200. When the male coupler 100 is secured to the female coupler 200, the securing bearings 240 may be in the gap between the first fixing ridge 132 and the second fixing ridge 134 with the latches 230 securing the securing bearings 240 in the gap between the first fixing ridge 132 and the second fixing ridge 134 and the first holder 252 applying a force to the shaft 234 of the latch to maintain the first head 236 of the latch 230 in the position for securing female coupler 200 to the male coupler 100 (e.g. in contact with the securing bearings 240). The securing bearings 240 may be able to move within the second fixing portion 220 of the female coupler such that when the first head 236 is not pushing on the securing bearings 240, the securing bearings 240 may move enough to allow the bearings to pass over the second fixing ridge 134. In this way, when the first head 236 is not pushing on the securing bearings 240, the male coupler 100 may be moved into or out of the female coupler 200. The central portion 120 may be wider than the first and second fixing ridges 132, 134 and the hole in the female coupler 200 to stop the male coupler 100 from going too far into the female coupler 200. Individually the male coupler 100 and the female coupler 200 may be about 1.5-3 inches long. The total length of the male coupler 100 and female coupler 200 when connected may be about 2.5-5 inches.

FIG. 1C shows an example front view of the male coupler 100 and the female coupler 200 according to the first embodiment of the inventive concepts. The front view being of the side of the male coupler 100 and female coupler 200 that is to the left in FIG. 1A. The male coupler 100 may additionally include a hole 160 passing through a center of the male coupler 100. The first fixing portion 110 may include threads 112 configured to secure the male coupler 100 to an object such as a firearm (not shown in this figure). In some embodiments, the first heads 236 may contact each other in the position for securing the female coupler 200 to the male coupler 100. The first heads 236 may be rounded such that the first heads 236 may together form a ring around the securing bearings 240. Advantageously, if the materials of the male coupler 100 and female coupler 200 are heated and expand, the ring of first heads 236 will not lock up (where a solid ring might lock up due to expansion) and the female coupler 200 may still be decoupled from the male coupler 100. Although 4 latches 230 are shown with 12 securing bearings 240, 2-6 latches 230 may be used with 4-18 securing bearings 240.

The female coupler 200 may include a hole 260 through a center of the female coupler 200. The first head 236 of the latch 230 is shown in the position for securing the female coupler 200 to the male coupler 100. In this position the securing bearings are pushed toward a center of the female coupler 200. The second securing portion may include a stopper 224 arranged to prevent the male coupler 100 from going too far into the female coupler 200 to ensure that the securing bearings 240 do not go over the first fixing ridge 132. Advantageously, the shape of the male coupler 100 and the female couple 200 allows for the male coupler 100 and the female coupler 200 to be connected at any rotational orientation in the plane shown in FIG. 1C. This advantage allows for much quicker attachment of the female coupler 200 to the male coupler 100 because the female coupler 200 and male coupler 100 do not have a certain rotational alignment in the plane shown in FIG. 1C when attached.

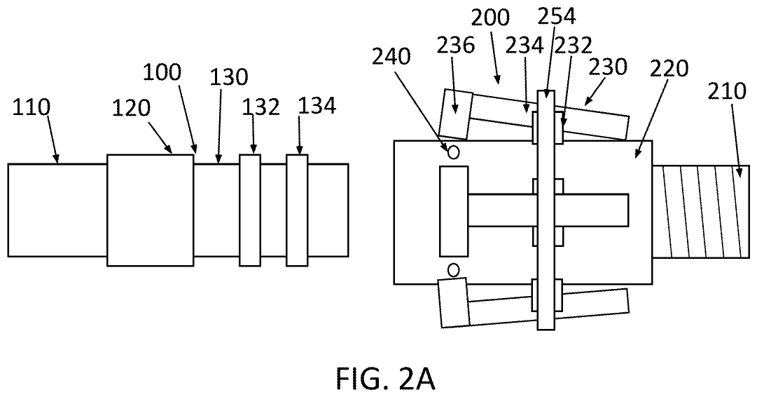

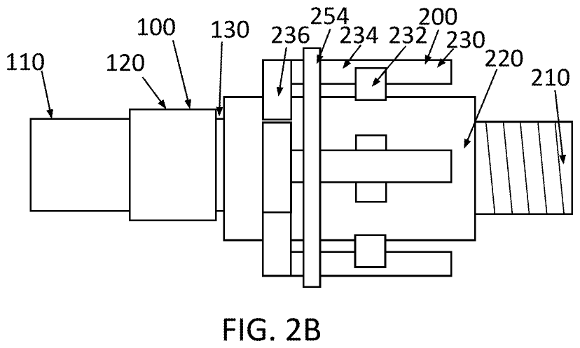

FIG. 2A shows another example side view of the male coupler 100 and the female coupler 200 according to a second embodiment of the inventive concepts. The female coupler 200 of FIG. 2A does not include the first holder 252 but instead includes the second holder 254. The second holder 254 may include a ring or a similar structure of stiff material (such as metal) or elastic material (such as rubber). The second holder 254 may be arranged to slide on the shafts 234. When the second holder 254 is slid to a position proximate to the base 232 (as shown in FIG. 2A) on the shaft 234, the holder may not apply a significant force to the shaft 234 and not secure the first head 236 in the position for securing the female coupler 200 to the male coupler 100. In this position the male coupler 100 may be moved into or out of the female coupler 200. In some example embodiments of the inventive concepts, the first holder 252 and the second holder 254 may both be used together. Restated, use of the first holder 252 and use of the second holder 254 are not mutually exclusive.

FIG. 2B shows another example side view of the male coupler and the female coupler when connected according to the second embodiment of the inventive concepts. When the second holder 254 is slid to a position proximate to the first head 236 on the shaft 234, the holder may apply a force to the shaft 234 that secures the first head 236 in the position for securing the female coupler 200 to the male coupler 100. In this position, the male coupler 100 may be secured in the female coupler 200. Advantageously, if the materials of the male coupler 100 and female coupler 200 are heated and expand, the second holder 254 will not lock up because there is room for the second holder 254 to deform from a ring shape to a more polygonal shape (for example, square shape if the female coupler 200 includes 4 latches 230) and the female coupler 200 may still be decoupled from the male coupler 100. In some embodiments, the second holder 254 may be secured in the position proximate to the first heads 236 and not move along the shaft 234.

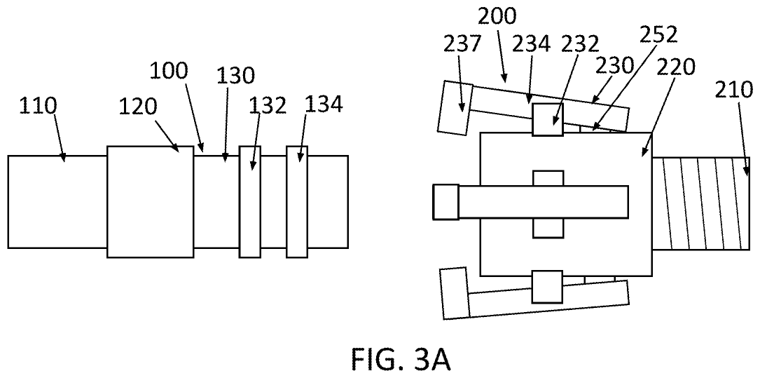

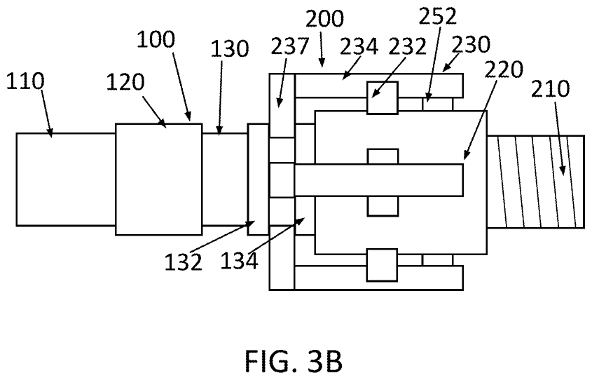

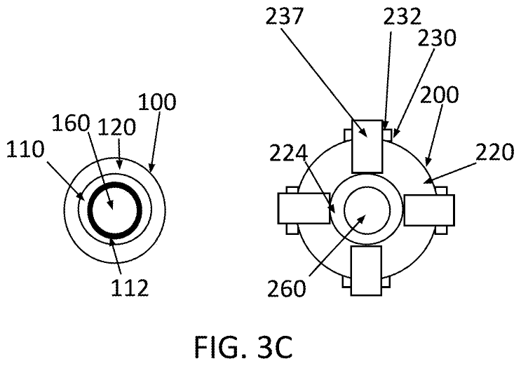

FIG. 3A shows another example side view of the male coupler 100 and the female coupler 200 according to a third embodiment of the inventive concepts. The female coupler 200 may include a substantially shorter second securing portion 220. Further, the latches 230 may include a second head 237 which is arranged to directly secure the female coupler 200 to the male coupler 100 when in the position for securing the female coupler 200 to the male coupler 100 by sitting in the gap between the first fixing ridge 132 and the second fixing ridge 134.

FIG. 3B shows another example side view of the male coupler 100 and the female coupler 200 when connected according to the third embodiment of the inventive concepts. The second fixng ridge 134 may act as a stopper to prevent the male coupler 100 from going too far into the female coupler 200 and assists in aligning the second heads 237 with the gap between the first fixing ridge 132 and the second fixing ridge 134. The first holder 252 may apply a force to the shaft 234 in order to maintain the second head 237 in the position to secure the female coupler 200 to the male coupler 100 (e.g., in the gap between the first fixing ridge 132 and the second fixing ridge 134).

FIG. 3C shows another example front view of the male coupler 100 and the female coupler 200 according to the third embodiment of the inventive concepts. The front view being of the side of the male coupler 100 and female coupler 200 that is to the left in FIG. 3A. The female coupler 200 is shown with 4 latches, however, in some embodiments 2-6 latches may be used. Advantageously, the shape of the male coupler 100 and the female coupler 200 allows for the male coupler 100 and the female coupler 200 to be connected at any rotational orientation in the plane shown in FIG. 3C.

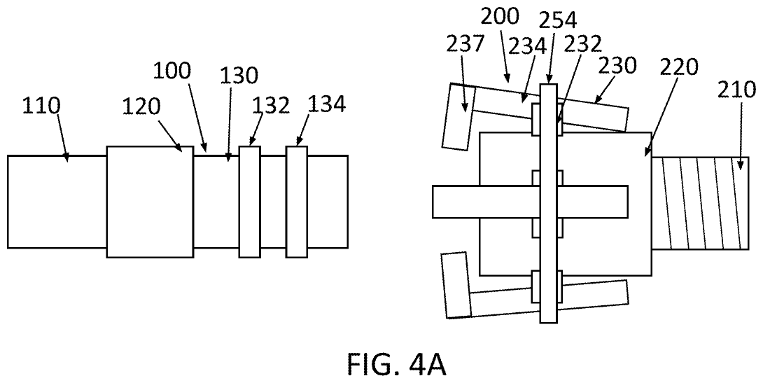

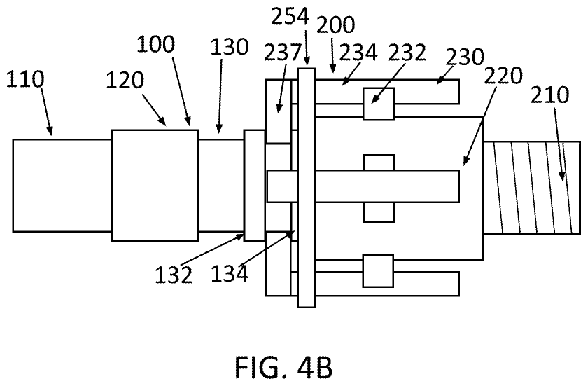

FIG. 4A shows another example side view of the male coupler 100 and the female coupler 200 according to a fourth embodiment of the inventive concepts. The female coupler 200 includes the second holder 254 and the second head 237 in the latch 230.

FIG. 4B shows another example side view of the male coupler 100 and the female coupler 200 when connected according to the fourth embodiment of the inventive concepts. The female coupler 200 includes the second holder 254 and the second head 237 in the latch 230.

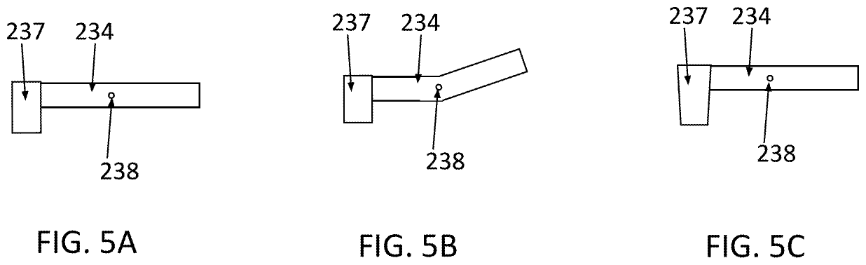

FIGS. 5A-5C show example side views of the shaft 234 and head 237 of the latch 230. FIG. 5A shows a shaft 234 that is straight and includes a hole 238 for a pin (not shown) to attach the shaft 234 to the base 232. The second head 237 has substantially parallel sides. The substantially parallel sides are advantageous for maintaining the head in the gap between the first fixing ridge 132 and the second fixing ridge 134 when an explosive force (such as from a bullet being fired) pushes the female coupler 200 in a direction perpendicular to the substantially parallel sides of the head 237.

FIG. 5B shows a shaft 234 that is bent. The bend in the shaft 234 is centered on the hole 238 where the shaft 234 rotates. The bent shaft 234 allows for a larger rotational range of motion of the second head 237 (or first head 236 if the first head 236 is attached to the shaft 234), because the shaft 234 will not contact the second fixing portion 220 as quickly when the second head 237 is moved from the position for securing the female coupler 200 to the male coupler 100.

FIG. 5C shows a second head 237 that does not have parallel sides. The non-parallel sides of the second head 237 may be advantageous for quickly coupling and decoupling the male couple 100 and female coupler 200 because the shape of the head allows for greater error in initial placement of the second head 237 and allows the second head 237 to slide into the gap between the first fixing ridge 132 and the second fixing ridge 134.

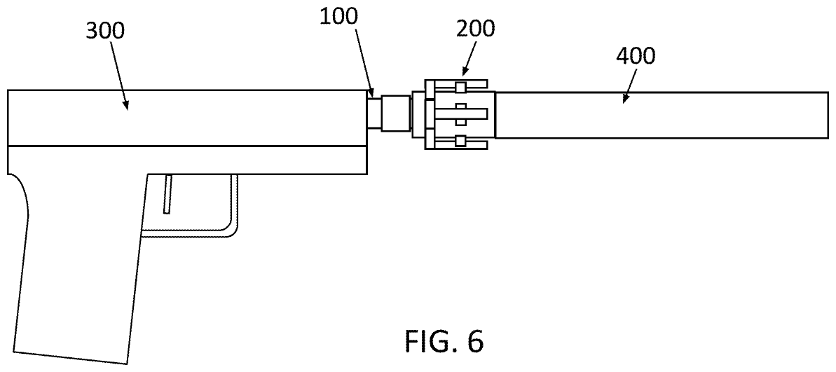

FIG. 6 shows an example side view of the male coupler 100 and female coupler 200 connecting a suppressor 400 to a firearm 300. The male coupler 100 may be connected to the firearm 300 (e.g., screwed together) via the threads 112 of the male coupler 100 and complimentary threads on the barrel of the firearm 300. The female coupler 200 may be connected to the male coupler 100 according to any of the embodiments of the inventive concepts discussed above. The female coupler 200 may be connected to the suppressor 400 (e.g., screwed together) via the threads of the first fixing portion 210.

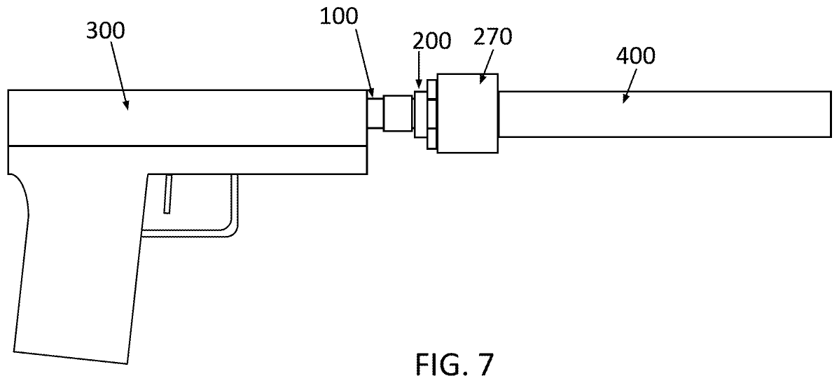

FIG. 7 shows another example side view of the male and female couplers connecting a suppressor to a firearm. The female coupler 200 may further include a sleeve 270. The sleeve 270 may be silicon, rubber, or another insulating material. In some embodiments, the sleeve 270 may be elastic and be an example of the second holder 254. In other embodiments, the sleeve 270 may function as a grip and insulator so that a bare hand may be used to detach the female coupler 200 from the male coupler 100 even after the firearm 300 has been fired several times heating the female coupler 200. The sleeve 270 may be sufficiently malleable such that a person may use manual pressure around the female coupler 200 to lift each of the latches 230 from the position securing the female coupler 200 to the male coupler 100 by squeezing the sleeve 260. The sleeve 260 may cover all or a portion of the female coupler 200 and may also cover all or portions of the male coupler 100 (when the female coupler 200 is connected to the male coupler 200) and the suppressor 400 (when the female coupler 200 is connected to the suppressor 400). The sleeve may have a ring shape with a diameter complimentary to the side of the female coupler 200 and a length of about 0.75 inches to 8 inches.

The male coupler 100 and female coupler 200 may be used for quickly attaching and detaching the suppressor 400 to the firearm 300 even when the firearm is being used. For example, the male connector 100 may be connected to the barrel of the firearm 300 and the female connector 200 may be connected to the suppressor 400 before the firearm is used. When desired, the female connector 200 and suppressor 400 may be connected to the male coupler 100 and firearm 300 by squeezing the shafts 234 of the latches 230 on the side opposite the heads 236 or 237 to overcome the force applied by the holders 252 or 254 (in some cases the second holder 254 may also be moved to reduce the force applied) to move the heads 236 or 237 away from the position for securing the female coupler 200 to the male coupler 100, then inserting the second fixing portion 130 of the male coupler 100 into the second fixing portion 220 of the female coupler 200 until the male coupler 100 contacts the stopper 224, then releasing the latches 230 such that the latches 230 move back to the position for securing the female coupler 200 to the male coupler 100. As stated above, the rotational orientation of the male coupler 100 and the female coupler 200 may not matter when connecting the male coupler 100 and the female coupler 200. When desired, the female coupler 200 and the suppressor 400 may be removed from the male coupler 100 and firearm 300 (even when substantial heat has accumulated) by again squeezing the shafts 234 of the latches 230 on the side opposite the heads 236 or 237 to overcome the force applied by the holders 252 or 254 (in some cases the second holder 254 may also be moved to reduce the force applied) to move the heads 236 or 237 away from the position for securing the female coupler 200 to the male coupler 100, then removing the second securing portion 130 of the male coupler 100 from the second securing portion 220 of the female coupler 200. Accordingly, using the male coupler 100 and the female coupler 200, a suppressor 400 may be connected to or removed from a firearm 300 very rapidly.

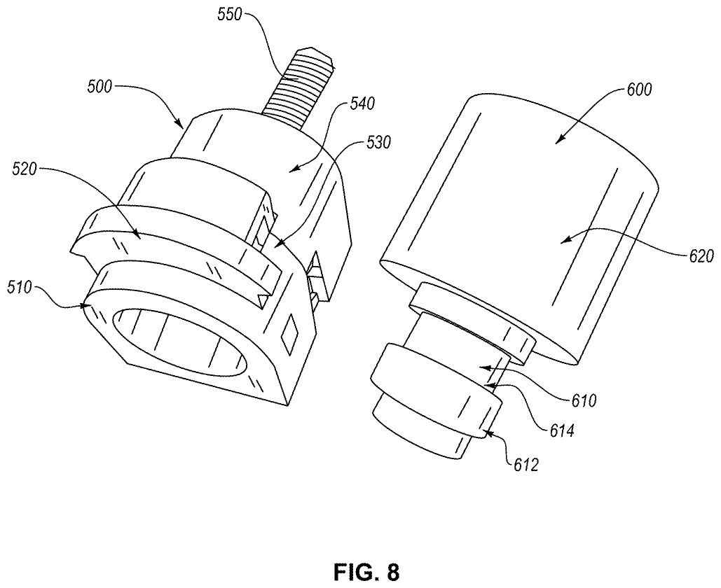

FIG. 8 shows an example top view of a second male coupler 600 and a second female coupler 500. The second male coupler 600 may have the target object 620 attached or integrated into the second male coupler. The target object 620 may be the object that is desired to be attached to another device. The second male coupler may include a male connection projection 610 which includes a raised area 612 and a recessed area 614. The male connection projection 610 may have a generally cylindrical shape so the male connection projection 610 may connect to the second female coupler 500 at any rotational orientation. In embodiments where the rotational orientation of the target object 620 matters, a different cross-sectional shape such as an oval shape or polygonal shape may be used. The recessed portion 614 may have a smaller diameter (if a circle in cross section) than the raised area 612 such that the recessed area forms a recess between the raised portion 612 and the target object 620 or another raised portion.

The second female coupler 500 may include a first fixing portion 550, a body (made up of a front portion 510, a middle portion 530 and a back portion 540) and a locking insert 520. the body may have a first opening defined through the front portion 510 and the middle portion 530 and optionally into the back portion 540 as well. The first opening may be sized and arranged to receive the male connection projection 610. The locking insert 520 may be inserted into the body in a second opening defined by and between the front portion 510 and the middle portion 530. The second opening may connect with the first opening such that the locking insert 520 may be inserted into the second opening and the locking insert 520 may contact the male connection projection 610 in the recessed area 614 such that the male projection is securely fixed in the first opening. The first opening may be sized so the male connection projection 610 snugly fits in the first opening (in some embodiments being only about a 1-5% larger than the diameter of the raised area 612).

The body may also define a third opening defined by and between the middle portion 530 and the back portion 540. The third opening may extend completely through the body. The third opening may be on the same side of the body as the second opening. The third opening may be sized and configured so that the locking insert 520 may be inserted into the second opening and the third opening at the same time. The locking insert 520 may be secured in place in a locking position via the third opening.

The first fixing portion 520 may be a screw, or other form of fixing instrument that can connect the body to the first device. The first device may be any type of object. The first fixing portion 520 may be attached to the back portion 540 of the body on a side of the body opposite the side through which the first opening is defined. Thus the target object 620 may be attached to the first device in the same orientation as a device would be connected using the first fixing portion 520.

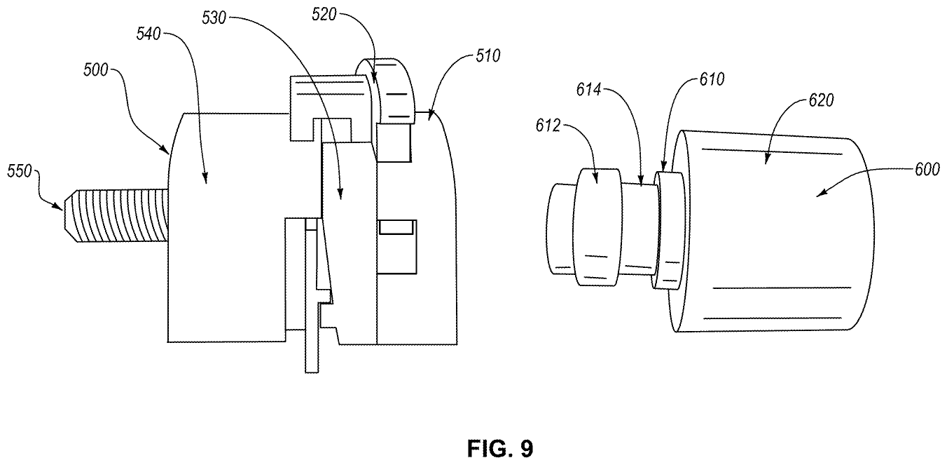

FIG. 9 shows an example side view of the second male coupler 600 and the second female coupler 500. The second male coupler 600 and the second female coupler 500 are shown in an unconnected manner with the second female coupler 500 shown in an open or unlocked position where the locking insert 520 is raised up (or not fully inserted) in the second and third openings such that the male connection projection 610 can move in and out of the first opening. A connecting opening between the second and third openings may be defined by the middle portion.

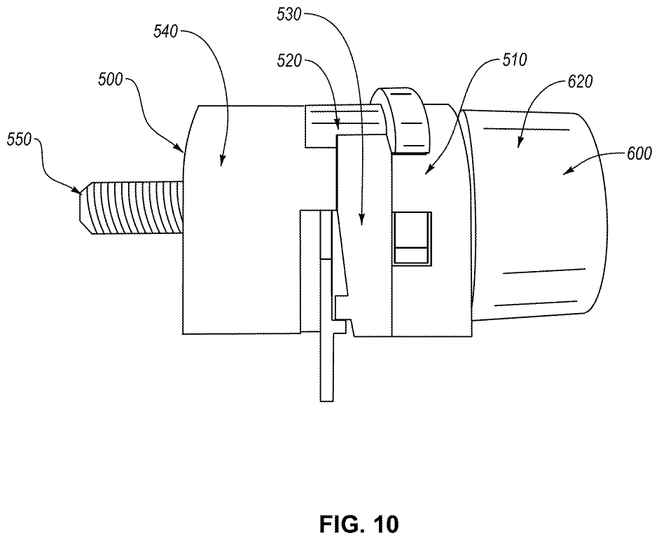

FIG. 10 shows an example side view of the second male coupler 600 and the second female coupler 500 coupled together. The second female coupler 500 is shown in a locked position with the locking insert 520 pressed down into the second and third openings. In the locked position, projections from the locking insert 520 and the middle portion 530 may interact to lock the locking insert in place. Although not visible, the locking insert 520 may be inserted into the recess 614 in the male connection projection 610 to secure the male connection projection 610 in the first opening. Restated, in the locked position, the locking insert 520 may prevent the male connection projection 610 from leaving the first opening in the body.

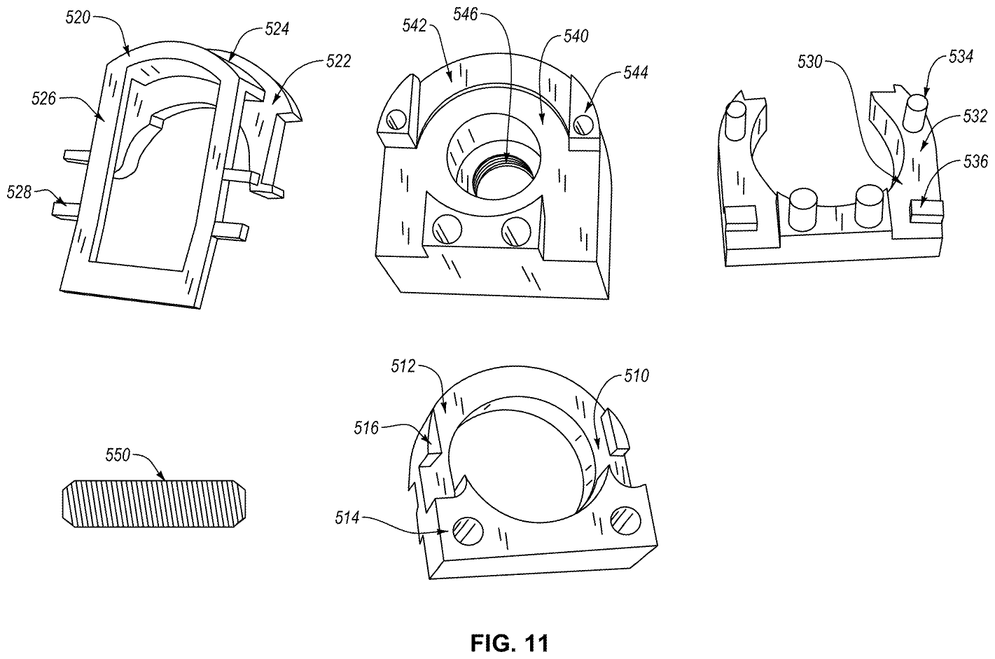

FIG. 11 shows component parts of the female coupler 500. The front portion 510 may include a front portion body 512, side projections 516, and front portion base 514. The middle portion 530 may include a middle portion base 532, middle portion connection pegs 534, and locking projections 536. The back portion 540 may include a back portion base 542, connection projections 544, and a connector 546. The locking insert 520 may include a locking insert base (or lock) 522, a connection extension 524, and a latch 526 with locking projections 528.

The front portion body 512 which defines the first opening through the front portion 510 and also partially defines the second opening with the front portion base 514 and the side projections 516. The side projections 516 may extend from the front portion base 512 on either side of the first opening (left side and right side of the first opening in the view of FIG. 11) of the base with a gap between the side projections 516 and the front portion base 514. The gap between the side projections 516 and the front portion base 514 may determine the movement distance of the locking insert 520 between the open or unlocked position and the locked position because projections off the locking insert base 522 may be limited in movement by the size of the gap. The front portion base 514 may be thicker than the body 512 or project from the body 512 and may define openings for connection pegs 534 to connect the front portion 510 to the middle portion 530. The opposite side of the front portion 530 (side not shown and opposite the side with the indents in the base 514) may be substantially flat other than the connection pegs 534 that insert into the front portion base 514.

The middle portion base 532 may partially define the first opening and define the connection opening between the second opening and the third opening. The connection opening may connect with the first opening in some embodiments. In other embodiments, the connection opening may not connect with the first opening. The connection pegs 534 may extend from the middle portion base 532 and be arranged and sized to be inserted into the holes defined in the front portion base 514 and back portion projections 544. The connection pegs 534 may connect the pieces of the body by friction alone or with glues or other securing means. The middle portion base 532 may decrease in thickness around the locking projections 536 and near a bottom (from the perspective of FIG. 11) base. This allows the latch 526 to have room to move around the locking projections 536 to lock under the locking projections 536 and unlock when moved out from under the locking projection 536. The connection pegs 534 on the middle portion 530 may be arranged on the side with the locking projection 536 to connect to the back portion 540 on either side of the first opening and underneath the first opening (from the perspective of FIG. 11). The connection pegs 534 on the side opposite the locking projections 536 are arranged to connect to the front portion 510 at a bottom of the front portion 510 at the front portion base 514.

The back portion base 540 may partially define the first opening and may define a portion of the first opening that is smaller in diameter than the diameter of the first opening through the front portion 510 and middle portion 530. The first opening defined by the back portion base 542 may be arranged and configured to secure a portion of the male connection projection with a smaller diameter than the raised portion 612 which extends out beyond the raised portion 612. The connection projections 544 may extend out from the base 542 such that the connection projections 544, the back portion base 542 and the middle portion base 532 define the third opening. The third opening may extend through the entire length of the base 542 and on either side of the connection projection 544 on the bottom of the back portion base 542.

The connector 546 may take many forms. The connector 546 may act as a direct connection to the first device. For example, the connector 546 may be a threaded area of the back portion base configured to receive a screw to connect to a first device. The connector 546 may also take the form of a clamp, latch, or other form of connector that may connect to another device.

The first fixing portion 550 may be a connector for connecting the bottom portion 540 to the first device. The fixing portion 550 may be a screw that can thread into the connector 546 or otherwise be attached to the connector 546. The first fixing portion 550 may be a screw that goes through the back portion 540 with only a head which is wider than the threaded portion engaging with the back portion 540 and the connector 546 may be a simple hole in the back of the base.

The locking insert base 522 may be sized and arranged to engage with the recess in the male connection projection 610 when the locking insert base 522 is inserted into the second opening to a locked position. The locking insert base 522 may also have projections on either side that interact with the side projection 516 of the front portion 510 to keep the locking insert 520 from detaching from the female coupler 500. The locking insert base 522 may be connected to the latch 526 by the connection extension 524. The connection extension 524 may have a similar width or substantially the same width as the middle portion 530 such that the connection extension 524 passes over the middle portion 530 and connects the locking inserts base 522 and the latch 526 on either side of the middle portion 530 when the locking insert 520 is in the second opening and the third opening.

The latch 526 may have an open center such that the latch 526 passes around the first opening and the connection projection 544 on the bottom of the back portion 540 when the latch is in the third opening. The latch 526 may also include locking projections 528 which are sized and arranged on the latch 526 to engage with the locking projections 536 to lock the latch in a locked position when the latch 526 is pressed down into the third opening. The bottom of the latch 526 may stick out the bottom of the back portion base 542 or otherwise be accessible to a human finger or hand such that the latch can be pressed toward the back portion 540 and up to release the locking projections 536 from the locking projections 528. The latch 526 may also have other projections which keep the latch 526 from leaving the third opening when in the open position.

The latch 526 and the locking insert base 522 may not be parallel and may be converging below the connecting extension 524 such that the latch 526 is pressed toward the center portion 530 when slid up and down in the third opening. This causes the locking projections 528 to engage with the locking projections 536 to lock under the locking projections 536 in a locked position when the latch 526 is pressed down into the third opening.

The second female coupler 500 may be constructed in the following manner. The middle portion 530 may be inserted between the locking inserts base 522 and the latch 526 of the locking insert 520 with the connection pegs 534 on the bottom of the middle portion 530 on the side with the locking projections 536 being located in the open center of the latch 526. The locking insert 520 may be placed on the front portion 510 with the projections of the locking insert base 522 in the gaps between the side projections 516 and the front portion base 514. The connection pegs 534 of the middle portion 530 on the side opposite the locking projections 536 may be inserted into the front portion base 514. The first fixing portion 550 may be secured to the connector 546. The connection pegs 534 of the middle portion 530 on the side of the locking projections 536 may be inserted into the connection projections 544 of the back portion 540.

The front portion 510, middle portion 530, and back portion 540 may be made of metal, plastic, or other durable material with suitable strength for the connection between the first device and the target object 620. The locking insert 520 may be made of metal, plastic, or other durable material with a springy material used at least in the latch 526 such that the latch 526 is not damaged by bending the latch 526 to disengage the locking projections 528. The male connection projection 610 may include metal, plastics, or other durable material with suitable strength for the connection between the first device and the target object 620. The target object 620 may be any form of object desired to be connected to the first device.

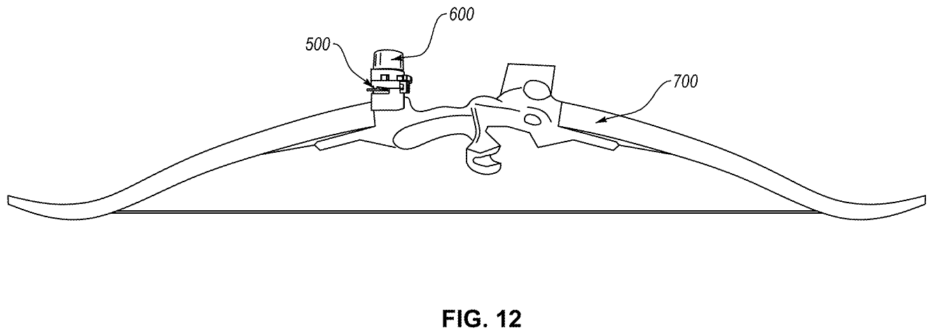

FIG. 12 shows the second female coupler 500 and the second male coupler 600 used to connect a stabilizer to a bow 700. The stabilizer 620 may be an example of a target object 620. The bow 700 may be an example of the first device. The stabilizer is normally connected by a screw. The first fixing portion 550 of the second female coupling device 500 may operate as the screw to connect the bow to the first female coupling device 500. The second male coupling device 600 may then be connected to the second female coupling device 500 to connect the stabilizer 620 to the bow 700. In some embodiments, the target object 620 may be separate from the second male coupler 600. The second male coupler 600 may then include a second connection device such as first fixing portion 110 of FIG. 1 which may be used to connect to the target device 620.

The second male coupling device 600 and the second female coupling device 500 may be used to quickly and securely couple two objects. As described above, the second male coupling device 600 and the second female coupling device 500 may be quickly and securely connected by the locking insert 520 being placed in an open position and inserting the male connection projection 610 into the first opening of the base and then pressing down on the top of the locking insert 520 to place the locking insert 520 into a locked position. Similarly, the second male coupling device 600 and the second female coupling device 500 can be quickly decoupled/disconnected by pressing the bottom of the latch 526 toward the back portion 540 and up to move the locking insert 520 to the unlocked or open position and removing the male connection projection 610 of the second male coupling device 600 from the first opening in the base.

Many different embodiments of the inventive concepts have been shown. A person of ordinary skill in the art will appreciate that the features from different embodiments may be combined or replaced with other features from different embodiments.

In one embodiment, the coupling device may include a first coupling member (for example second female coupler 500) and second coupling member (for example second male coupler 600). The first coupling member may include a body defining a first opening on a first side of the body and a second opening on a second side of the body different from the first side of the body. The first opening and the second opening may connect. The first coupling member may include a locking insert 520 configured to enter into the first opening. The second coupling member may include a first portion (for example first male connection projection 610) defining a recess. The first portion may be configured to be inserted into the first opening and secured in the first opening by the locking insert 520.

The first coupling member may further include a first connector (for example the first fixing portion 550) configured to connect to a first device. The body may further define a third opening in the second side. The locking insert 520 may include a latch 526 which is configured to enter into the third opening and a lock 522 configured to enter into the second opening. The lock 522 may be configured to contact the first portion to secure the first portion in the first opening and the latch 526 is configured to secure the locking insert 520 in the second opening and the third opening when the locking insert is inserted into the second opening and the third opening. The lock 522 may be configured to secure the first portion in the first opening by being inserted into the recess in the first portion.

The third opening may extend completely through the body. The latch 526 may define an opening through which the first portion may pass when the locking insert is inserted into the second opening and the third opening. The latch 526 may include at least one projection (for example the locking projection 528) which engages with the body to lock the locking insert 520 in a locking position. The lock 522 may be configured to secure the first portion in the first opening if the first portion is in the first opening.

The body may include a front portion 510, a middle portion 530, and a back portion 540. The front portion 510 and middle portion 530 may together define the first opening. The front portion 510 and the middle portion 530 may together define the second opening. The middle portion 530 and the back portion 540 may together define the third opening. The locking insert 520 may include a connecting piece (for example the connection extension 524) between the latch 526 and the lock 522. The middle portion 530 defines a connecting opening between the first opening and the second opening. The connecting piece may be configured to at least partially sit in the connecting opening when the locking insert 520 is in the locking position.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A coupler including:
a first connector configured to connect to a first device;
a body defining a first opening on a first side of the body and a second opening on a second side of the body different from the first side of the body, wherein the first opening is configured to receive a portion of a second device, wherein the first opening and the second opening connect, and wherein the first connector is fixed to the body via a third side; and
a locking insert configured to enter into the second opening and secure the portion of the second device in the first opening.

2. The coupler of claim 1, wherein the third side is opposite the first side on the body.

3. The coupler of claim 1, wherein the body further defines a third opening in the second side, wherein the locking insert includes a latch which is configured to enter into the third opening and a lock configured to enter into the second opening, wherein the lock is configured to contact the portion of the second device to secure the portion of the second device in the first opening and the latch is configured to secure the locking insert in the second opening and the third opening when the locking insert is inserted into the second opening and the third opening.

4. The coupler of claim 3, wherein the lock is configured to secure the portion of the second device in the first opening by being inserted into a recess in the portion of the second device.

5. The coupler of claim 3, wherein the third opening extends completely through the body.

6. The coupler of claim 3, wherein the latch defines an opening through which the portion of the second device may pass when the locking insert is inserted into the second opening and the third opening.

7. The coupler of claim 3, wherein the latch includes at least one projection which engages with the body to lock the locking insert in a locking position, wherein the lock is configured to secure the portion of the second device in the first opening if the portion of the second device is in the first opening.

8. The coupler of claim 7, wherein
the body includes a front portion, a middle portion, and a back portion,
the front portion and the middle portion together define the first opening,
the front portion and the middle portion together define the second opening, and
the middle portion and the back portion together define the third opening.

9. The coupler of claim 8, wherein the first connector is fixed to the back portion.

10. The coupler of claim 8, wherein
the locking insert includes a connecting piece between the latch and the lock,
the middle portion defines a connecting opening between the first opening and the second opening, and
the connecting piece is configured to at least partially sit in the connecting opening when the locking insert is in the locking position.

11. A coupler including:
a first coupling member including:
a body defining a first opening on a first side of the body and a second opening on a second side of the body different from the first side of the body, wherein the first opening and the second opening connect; and
a locking insert configured to enter into the second opening; and
a second coupling member including a first portion defining a recess, wherein the first portion is configured to be inserted into the first opening and secured in the first opening by the locking insert.

12. The coupler of claim 11, wherein the first coupling member further includes a first connector configured to connect to a first device.

13. The coupler of claim 11, wherein the body further defines a third opening in the second side, wherein the locking insert includes a latch which is configured to enter into the third opening and a lock configured to enter into the second opening, wherein the lock is configured to contact the first portion to secure the first portion in the first opening and the latch is configured to secure the locking insert in the second opening and the third opening when the locking insert is inserted into the second opening and the third opening.

14. The coupler of claim 13, wherein the lock is configured to secure the first portion in the first opening by being inserted into the recess in the first portion.

15. The coupler of claim 13, wherein the third opening extends completely through the body.

16. The coupler of claim 13, wherein the latch defines an opening through which the first portion may pass when the locking insert is inserted into the second opening and the third opening.

17. The coupler of claim 13, wherein the latch includes at least one projection which engages with the body to lock the locking insert in a locking position, wherein the lock is configured to secure the first portion in the first opening if the first portion is in the first opening.

18. The coupler of claim 17, wherein
the body includes a front portion, a middle portion, and a back portion,
the front portion and the middle portion together define the first opening,
the front portion and the middle portion together define the second opening, and
the middle portion and the back portion together define the third opening.

19. The coupler of claim 18, wherein the first coupling member further includes a first connector configured to connect to a first device and the first connector is fixed to the back portion.

20. The coupler of claim 18, wherein
the locking insert includes a connecting piece between the latch and the lock,
the middle portion defines a connecting opening between the second opening and the third opening, and
the connecting piece is configured to at least partially sit in the connecting opening when the locking insert is in the locking position.
